(19) United States
(12) Patent Application Publication
(10) Pub. No.: US 2026/0363226 A1
(43) Pub. Date: Nov. 19, 2026

(54) PORTABLE INSECT LIGHT TRAP DEVICE

(71) Applicant: S. C. JOHNSON & SON, INC., Racine, WI (US)

(72) Inventors: Kamran FATERIOUN, New Berlin, WI (US); Mark A. COMER, Racine, WI (US); Shabistan SHEERIN, Sturtevant, WI (US); Heather J. Swanson, Racine, WI (US)

(21) Appl. No.: 19/678,846

(22) Filed: May 15, 2026

Related U.S. Application Data
(60) Provisional application No. 63/807,349, filed on May 16, 2025.

(51) Int. Cl. A01M 1/14

(52) U.S. Cl. CPC A01M 1/145; A01M 2200/012

(57) ABSTRACT

An insect trap includes a base portion that defines a front surface and a rear surface opposite the front surface. The base portion includes electrically conductive prongs, a battery, a plurality of LEDs, and a light bar in optical communication with the plurality of LEDs. The insect trap also includes a front housing, a pillar extending from the base portion to the front housing, and a planar substrate.

### CROSS-REFERENCE TO RELATED APPLICATIONS

This application claims the benefit of and priority to U.S. Provisional Application No. 63/807,349, filed on May 16, 2025, which is incorporated by reference herein in its entirety, for any and all purposes.

### BACKGROUND

Insect control within indoor spaces remains an ongoing concern for both residential and commercial environments. Traditional methods often involve chemical treatments or noisy devices that may not align with modern preferences for non-toxic, aesthetically pleasing, and quiet solutions. There is a growing demand for discreet and visually appealing insect traps that can effectively manage flying or crawling pests in various indoor settings. These devices may utilize alternative attraction methods, such as specific light wavelengths, to draw and capture insects without relying on chemicals or producing disruptive sounds.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to some aspects of the present disclosure, an insect trap is provided. The insect trap includes a base portion defining a front surface and a rear surface opposite the front surface. The base portion includes electrically conductive prongs, a rechargeable battery housed within the base portion between the front and rear surfaces, a plurality of LEDs including at least one blue light LED and at least one UV light LED, and a light bar in optical communication with the plurality of LEDs, the light bar mounted in the front surface. The insect trap also includes a front housing including a shield structure having a first diameter, the shield structure including a central panel and a domed surface, the central panel includes at least one button and a light sensor, the front housing is spaced apart from the base portion in a first direction, and the base portion and the front housing defining an empty volume therebetween. In some embodiments, the insect trap also includes a pillar extending from the base portion to the front housing, the pillar at least partially joining the front housing and the base portion, such that the pillar includes a slot. Additionally, the insect trap includes a planar substrate sized to be received in the slot of the pillar, such that the diameter of the shield structure is greater than a maximum distance between two points along an outer edge of the planar substrate.

According to other aspects of the present disclosure, the insect trap includes one or more of the following features. The light bar is configured to direct light from the plurality of LEDs into the empty volume toward the planar substrate. The planar substrate is transparent, translucent, partially opaque, or opaque. In some embodiments, the insect trap further includes an eject button positioned on the pillar and a latch mechanically coupled to the eject button, such that the planar substrate includes a retention aperture, and when the planar substrate is received in the slot, the latch engages the retention aperture to secure the planar substrate in position. The at least one button includes a mode button, and the insect trap is configured to operate in at least two modes selectable by engaging the mode button. The at least two modes includes an “on” mode in which the plurality of LEDs remain activated, and an “auto” mode in which activation of the plurality of LEDs is controlled based on ambient light levels detected by the light sensor. In the “auto” mode, the plurality of LEDs are deactivated when the light sensor detects ambient light above a first threshold value and reactivated when the light sensor detects ambient light below a second threshold value. The at least one button includes a power button and a mode button, and pressing and holding at least one of the power button or the mode button adjusts an intensity of at least one LED of the plurality of LEDs. The insect trap includes a memory configured to store a user-selected intensity level, and the at least one LED returns to the user-selected intensity level upon reactivation after deactivation in an auto mode.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a top, front, and right isometric view of an insect trap including a housing and an adhesive refill, according to some examples.

FIG. 2 is a top, rear, and right isometric view of the insect trap of FIG. 1.

FIG. 3 is a bottom, front, and left isometric view of the insect trap of FIG. 1.

FIG. 4 is a front elevation view of the insect trap of FIG. 1.

FIG. 5 is a rear elevation view of the insect trap of FIG. 1.

FIG. 6 is a right side elevation view of the insect trap of FIG. 1.

FIG. 7 is a bottom plan view of the insect trap of FIG. 1.

FIG. 8 is a top, right, and isometric view of the insect trap of FIG. 1 with the adhesive refill removed.

FIG. 9 is an isometric view of the adhesive refill of FIG. 1.

FIG. 10 is a front elevation view of the refill of FIG. 1.

FIG. 11 is an exploded view of the insect trap of FIG. 1.

FIG. 12 is another exploded view of the insect trap of FIG. 1.

FIG. 13 is a block diagram of an insect trap according to some examples.

FIG. 14 is a flow chart for a process of an insect trap.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides solutions for catching flying insects without the use of insecticides. In one particular implementation, light is guided through a front lens to attract flying insects to an insect trap device. As disclosed hereinafter below, in some embodiments blue light and UV light are emitted, the combination of which has been found to be an effective way to attract certain insects. Once attracted to the device, a double-sided adhesive refill catches the insects. The refill is disposable and has adhesive portions that are specifically colored to attract certain insects in combination with the UV light. The refill includes an easy-to-peel feature, one or more grips for a user to grasp the refill, and/or a “lock-in” feature, among other advantages. The insect trap device described herein has been found to work well at attracting and catching insects during the daytime, which is typically a difficult time to attract insects. Through testing, it has been determined that the daytime efficacy is attributed to one or more of the front lens characteristics, the refill material colors and/or pattern, the use of a double sided adhesive, and/or the inclusion of UV LEDs.

Still further, because users are incentivized to use the insect trap device disclosed herein in non-conventional locations for insect traps, e.g., visible locations within a home, the efficacy of the device is improved over other devices. Users may be embarrassed that they have insects in their home, and may not want to draw attention to this fact. Because of the attractive profile of the device described herein, including the compact profile of the housing that holds the electronic components, users may freely display the insect trap within their homes in a similar fashion as a nightlight or a Glade® fragrance diffuser. Presently available light-based insect trap devices are not intended to be kept out in a similar fashion, since such devices have the appearance of a pest control product, and many such products use electroshock as a form of monitoring or eliminating insects.

The insect trap is configured to provide effective insect capture while minimizing visual discomfort or stigma associated with pest control devices. By obscuring visibility of captured insects and integrating illumination features that resemble ambient lighting or decorative elements, the insect trap may be placed in highly visible locations within indoor environments without causing embarrassment or aesthetic disruption. Increased placement flexibility may lead to improved overall effectiveness by allowing the insect trap to be positioned in areas of frequent insect activity. In some embodiments, the insect trap operates quietly and without mechanical movement or electroshock elements, thereby avoiding audible disturbances commonly associated with traditional insect traps. The absence of chemicals, insecticides, or audible killing mechanisms may further enhance user acceptance in residential, hospitality, healthcare, and food-related environments. In certain configurations, the insect trap is optimized to remain effective under a wide range of ambient lighting conditions, including daytime conditions. The combination of visible and ultraviolet illumination, reflective internal surfaces, and volumetric light distribution enables attraction of insects even when ambient light levels are relatively high, addressing limitations of conventional light-based insect traps that are primarily effective only in dark environments.

While the devices disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated. Throughout the disclosure, the terms “about” and “approximately” mean plus or minus 5% of the number that each term precedes.

Some examples of the disclosed subject matter provide insect trapping devices that can use light to attract insects to an adhesive surface of a replaceable refill substrate. The device can include features to facilitate a wall-mount configuration and a standalone configuration, and can further allow for portability of the insect trap device. For example, the insect trap can include electrically conductive prongs that can engage a wall socket to allow a mounting of the insect trap device at the wall socket. The insect trap device can further include a rechargeable battery that allows the insect trap device to be used in settings where it may be impractical or ineffective to mount the insect trap device at a wall. In some embodiments, as disclosed herein, the insect trap device can include a shield structure (e.g., a cover) that shields an adhesive surface of a refill from view of a user, to make the insect trap device more visually appealing to a user.

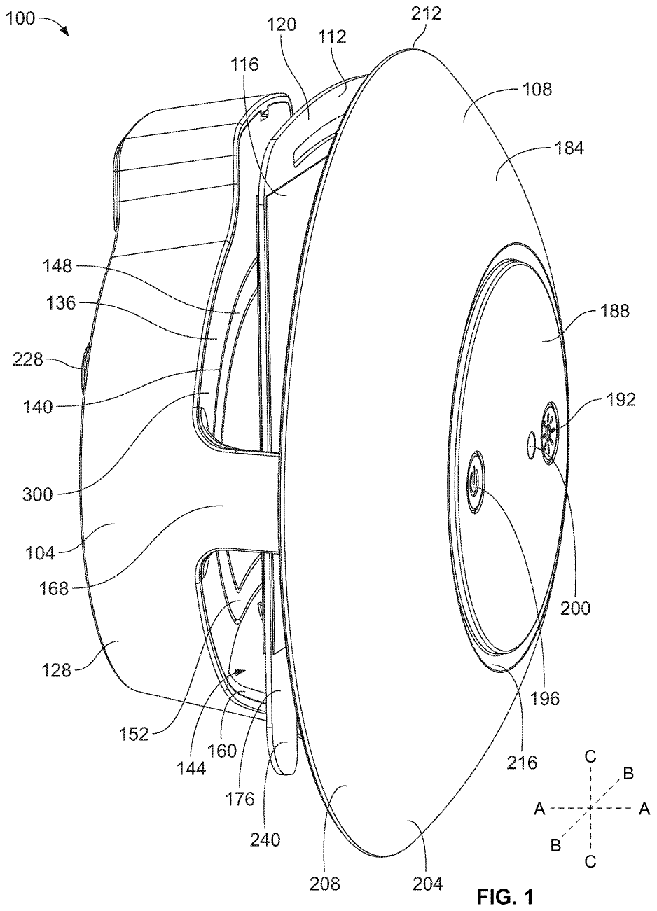

Referring now to the figures, FIGS. 1-12 illustrate an example insect trap 100. As shown in FIG. 1, directional axes A, B, C are provided for ease of description of the device 100. As shown, a depth direction of the insect trap device 100 is a direction parallel to axis A. The terms “front” or “in front” as used herein mean a relative position in a first direction along an axis parallel to axis A. The terms “rear”, “back”, or “behind” mean a relative position in a second direction opposite the first direction along an axis parallel to axis A. Further, as shown, the axis B defines a lateral direction for the insect trap device 100. With respect to FIGS. 1-12, a description of an element as being laterally opposed or at a lateral side indicates a relative position of respective elements along an axis parallel to axis B. As further shown, axis Cis a vertical axis, and is perpendicular to both of axes A and B. Unless otherwise specified, with respect to FIGS. 1-12 the terms “above,” “below,” “top,” and “bottom” are used to indicate a relative position of elements in respective directions along an axis parallel to axis C. Further, unless otherwise indicated, use of any relative direction (e.g., in front of, behind, above, below, etc.) does not require that an axis parallel to the reference direction extends through respective elements. Rather, a first element is in front of the second element if a plane extending through the first element and normal to the axis A is in front of a plane extending through the second element and normal to axis A.

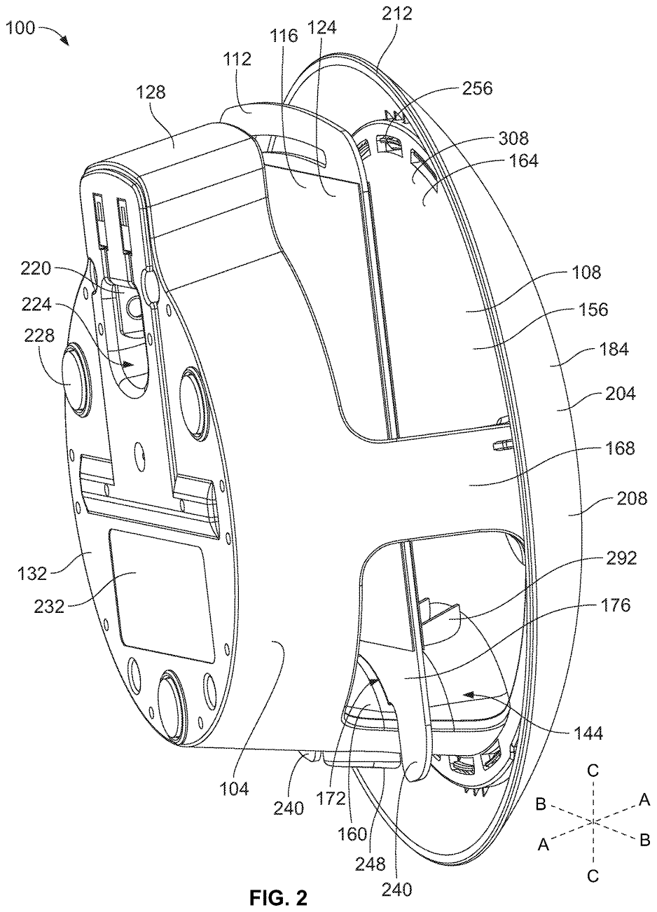

Referring specifically to FIG. 1, a top, front, and right isometric view is shown of the insect trap device 100. The device 100 includes a rear housing 104, a front housing 108, and a refill, substrate, or refill substrate 112 that is configured to be removably installed within the device 100. The substrate 112 is planar, and an adhesive surface 116 is provided on one or more surfaces (e.g., one or both of a front side 120 and a rear side 124 of the substrate 112). As discussed below, either or both of the rear housing 104 and the front housing 108 house electrical components of the insect trap device 100 (e.g., light emitting diodes (LEDs), printed circuit boards (PCBs), resistors, control elements, heating elements, one or more batteries, sensors, power conversion elements, etc.). Further, the rear housing 104 includes a base portion 128. As shown, the base portion 128 is spaced apart from the front housing 108 in a direction parallel to axis A (e.g., the front housing 108 is in front of the base portion 128). The base portion 128 defines a rear surface 132 (see FIG. 2) (e.g., a surface configured to face a wall or face a surface on which the insect trap device 100 is supported) and a front surface 136 (e.g., a surface facing the front housing 108). As shown in FIG. 1 and discussed further below, the front surface 136 of the base portion 128 includes a light bar 140 for directing a light from light emitting elements such as LEDs housed within the base portion 128 toward the refill 112.

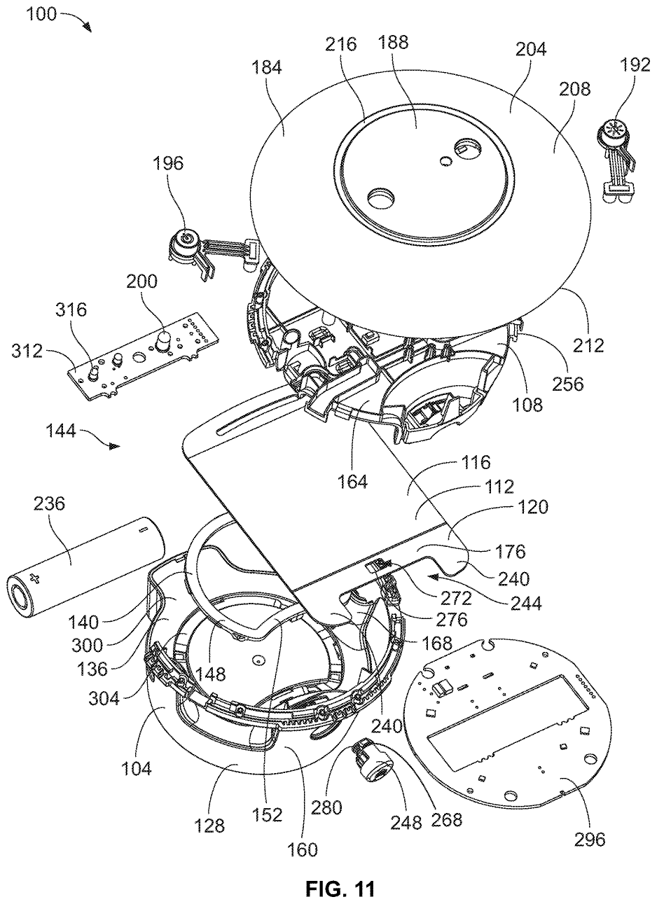

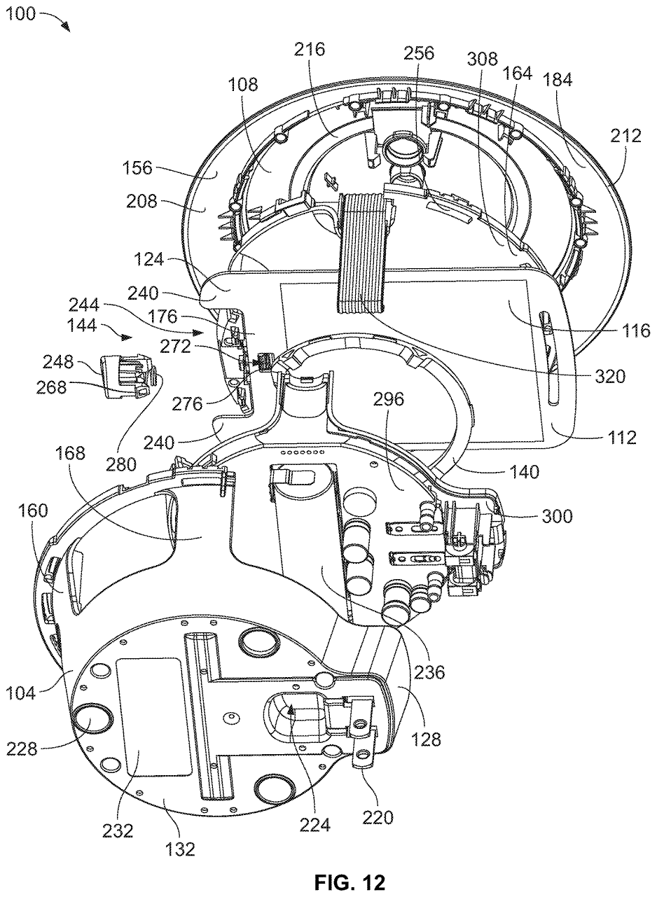

As further shown in FIG. 1, the base portion 128 is spaced apart from the front housing 108 defining an open space 144 (e.g., empty volume) therebetween. The substrate 112 is configured to be mounted within the open space 144 (e.g., between the base portion 128 and the front housing 108). Light emitting elements (e.g., LEDs, electroluminescent elements, fluorescent lights, fiber optic light sources, phosphorescent light sources, incandescent light sources, etc.) are housed within the base portion 128, and light from the light emitting elements is emitted into the open space 144 to lure insects into the open space 144 (e.g., toward the adhesive surface 116 of the substrate 112 within the open space 144). As described below, at least with respect to FIGS. 11 and 12, light elements within the base portion 128 include a combination of LEDs emitting visible light (e.g., blue light) and LEDs emitting UV light. In some embodiments, the light bar 140 is positioned directly in front of the LEDs within the base portion 128, and a front surface 148 of the light bar 140 is flush with the front surface 136 of the base portion 128. In some embodiments, light directed from the light bar 140 into the open space 144 is configured to be directed onto the adhesive surface 116 of the substrate 112, and insects attracted by the light are trapped on the adhesive surface 116 of the substrate 112.

In the illustrated example, the light bar 140 defines a generally circular profile, with an indented arc 152 at the bottom of the light bar 140. In some embodiments, the light bar 140 is transparent. In some embodiments, the light bar 140 is be constructed from various materials such as acrylic, polycarbonate, or other transparent or translucent polymers that allow for efficient light transmission. In some embodiments, the light bar 140 is configured as a light pipe or a light guide. In some embodiments, the light bar 140 is formed from other transparent or translucent materials (e.g., glass). In some implementations, the insect trap device 100 includes multiple light bars arranged in different configurations to provide optimal light distribution. In some embodiments, these light are of varying sizes, shapes, and materials to suit different design requirements. In some examples, the light bar 140 defines other shapes to allow for a direction of light in specified arrangements or patterns. For example, a profile of a light bar can define a line, a rectangle, a triangle, an oval, a star-shape, or any other shape configured to provide a desired amount and distribution of light to a refill of the insect trap device. In some embodiments, the light bar 140 is translucent (e.g., has a frosted texture). In some embodiments, the light bar 140 defines chamfers or other geometries to direct light in a desired pattern, or to divide a portion of a light from LEDs within a base of an insect trap device. In the illustrated example, the light bar 140 and the LEDs emitting light through the light bar 140 are positioned behind the substrate 112 (e.g., in the base portion 128) and shine light in a forward direction toward the substrate 112. In some embodiments, the insect trap device 100 includes LEDs (e.g., visible and UV light LEDs) within the front housing 108, and the light bar 140 is provided in the front housing 108 for directing light in a backward direction toward the substrate 112 mounted in the open space 144 of the insect trap device 100.

In some embodiments, the insect trap device 100 is configured such that light emitted from one or more light emitting elements is not directed toward the substrate 112 in a simple line-of-sight manner, but instead is distributed throughout the open space 144 defined between the base portion 128 and the front housing 108. The spatial relationship between the light emitting elements of the light bar 140, the planar substrate 112, and a rear surface 156 (see FIG. 2) of the front housing 108 is configured to produce a diffuse, volumetric illumination region into which insects are attracted from multiple approach angles. In some embodiments, this volumetric illumination increases capture efficiency by encouraging insects to traverse the open space 144 rather than merely approaching a localized point source of light. In certain implementations, the light bar 140 is configured to diffuse, refract, or otherwise alter the directional profile of light emitted before the light enters the open space 144. The light bar 140 includes one or more optical features such as curved surfaces, textured surfaces, chamfers, prisms, lenses, or internal scattering structures that cause light to spread laterally, vertically, or both. As a result, in some embodiments, light is directed toward both the rear side 124 (see FIG. 2) and the front side 110 of the planar substrate 112, either directly or via reflection from the rear surface 156 of the front housing 108.

Still referring to FIG. 1, the insect trap device 100 is configured such that at least a portion of the emitted light reflects off the rear surface 156 (see FIG. 2) of the front housing 108 and is redirected back toward the planar substrate 112. In some embodiments, these reflecting surfaces are specularly reflective, diffusely reflective, or partially reflective, and are coated, textured, or treated to modify reflectance characteristics. In some embodiments, the reflected light supplements direct illumination of the substrate 112, thereby increasing the apparent brightness of the adhesive surface 116 without increasing electrical power consumption. In some embodiments, the combination of visible and ultraviolet wavelengths, coupled with illumination of both the front side 120 and the rear side 124 (see FIG. 2) of the planar substrate 112, produces enhanced visual contrast and depth cues that increase the likelihood that insects will enter the open space 144 rather than merely circling the device 100. As a result, in some embodiments, the insect trap 100 exhibits improved capture rates during daylight hours or in continuously illuminated indoor spaces compared to traps that rely solely on ultraviolet emission or single-direction light projection. In some embodiments, lighting features of an insect trap device are provided to enhance an attractant effect, and to be visually appealing to a user.

Still referring to FIG. 1, in some embodiments the substrate 112 is transparent, and light from the light bar 140 is provided on the rear side 124 (see FIG. 2) of the substrate 112 (e.g., facing the base portion 128), and transmits through the substrate 112 to the front side 120 of the substrate 112 (e.g., facing the front housing 108). In some embodiments, the substrate 112 is translucent and is configured to allow a portion of light through the body of the substrate 112. For example, in some embodiments, the substrate 112 is made of clear polyethylene terephthalate (PET). In some embodiments, the substrate 112 is either transparent or translucent to allow light to pass through the substrate 112 and toward the front housing 108, which reflects some of the light outward. In some embodiments, the substrate 112 is made from a clear polypropylene (PP). In some embodiments, the substrate 112 is opaque. In some embodiments, the front housing 108 further includes features that provide a desired visual effect and insect trapping effectiveness for the insect trap device 100. For example, in some embodiments, the rear surface 156 (see FIG. 2) of the front housing 108 (e.g., a surface facing the base portion 128 and at least partially defining the open space 144) is reflective, and reflects a light from the LEDs in the base portion 128 (e.g., a light transmitted through the light bar 140) back into the open space 144, toward the substrate 112. In some embodiments, a reflected light from the front housing 108 is directed at the substrate 112 as it increases a trapping efficacy (e.g., a greater amount or intensity of light provides a stronger attractant for insects). In some embodiments, a reflective surface (not shown) of the front housing 108 directs light in a manner that provides a visual “halo” effect on a surface behind the insect trap device 100 (e.g., a wall when the insect trap device is in a wall-mount configuration, and a table-top, shelf, countertop, etc., when the insect trap device 100 is in a free-standing configuration).

According to some examples of the present disclosure, the insect trap device 100 includes support structures to physically link the front housing 108 and the base portion 128. Still referring to FIG. 1, in some embodiments, support structures include pillars extending from the base portion 128 to the front housing 108. In some embodiments, pillars of an insect trap device at least partially define a volume of an open space between a base portion and a front housing (e.g., a distance between a front surface of a base portion and a rear surface of a front housing in a direction parallel to axis A). For example, FIG. 1 illustrates a bottom pillar 160 that spans between the base portion 128 and the front housing 108. In the illustrated example, the bottom pillar 160 extends from the front surface 136 of the base portion 128 and terminates at a disc structure 164 (see FIG. 2) in contact with the front housing 108. Further, in the illustrated example, the insect trap device 100 includes lateral pillars 168. The lateral pillars 168 extend from opposite lateral sides of the front surface 136 of the base portion 128 and terminate at the disc structure 164 (see FIG. 2). In the illustrated example, the two lateral pillars 168 are positioned directly opposite each other along a lateral direction (i.e., along axis B). In other examples, pillars are positioned along a perimeter of a base structure at any angular interval to provide desired structural characteristics for an insect trap. In some embodiments, the insect trap device 100 device includes only one pillar joining a front housing to a base, or only two pillars. Further, in the illustrated example, the disc structure 164 (see FIG. 2), the lateral pillars 168, the bottom pillar 160, and the base portion 128 are integrally formed. In other examples, the pillars 168 are distinct pieces that are coupled to the base portion 128. In some embodiments, the pillars 168 are integral with the front housing 108. In some embodiments, the pillars 168 terminate directly at the rear surface 156 (see FIG. 2) of the front housing 108.

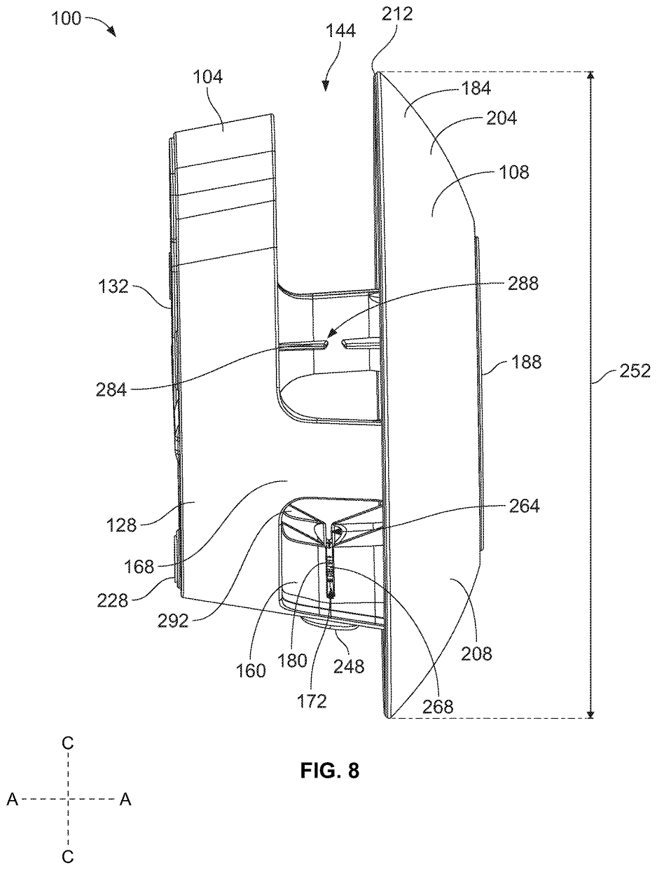

Still referring to FIG. 1, the lateral pillars 168 and the bottom pillar 160 of the insect trap device 100 are provided to support the substrate 112. For example, in some embodiments, the substrate 112 is at least partially supported by the bottom pillar 160. As discussed further below, in some embodiments, the bottom pillar 160 includes a slot 172 (see FIG. 2) that is configured to receive the substrate 112 and retain the substrate 112 relative to the rear and front housings 104, 108. In some embodiments, the substrate 112 is inserted into the open space 144 in an insertion direction (e.g., a downward direction along an axis parallel to vertical axis C) and is removed in a direction opposite the insertion direction. When inserted, a bottom portion 176 of the substrate 112 is received into the slot 172 (see FIG. 2) in the insertion direction, and engages a retention mechanism 180 (see FIG. 8) within the slot 172 (see FIG. 2) to constrain movement of the substrate 112 (e.g., to prevent inadvertent removal of the substrate 112 from the slot 172). In some examples, the bottom pillar 160 does not include the slot 172.

The insect trap device 100 also includes user-facing elements that presents a clean and visually appealing aesthetic for a user. In some embodiments, a user-facing side of an insect trap device 100 is configured to shield the refill 112 from view of a user when the insect trap device 100 is in use. Further, the user-facing elements include controls that are easily accessible to allow the user to manage an operation of the device. For example, as further shown in FIG. 1, the front housing 108 includes a shield structure 184 that is sized and positioned to be accessible and visible to a user when the insect trap device 100 is in a wall mount configuration (e.g., when the insect trap device 100 is supported at an electrical outlet (not shown)) and a free-standing configuration. In the illustrated example, the shield structure 184 includes a central panel 188 that includes a dimming button 192, a power button 196, and a light sensor 200 along a front surface 204 of the shield structure 184, which are visible and accessible to a user when the insect trap device 100 is in use. The shield structure 184 defines a generally dome-like shape, with a sloped portion 208 (e.g., domed surface) having a curved profile that extends outward and backward (e.g., in a direction toward the base portion 128) from the central panel 188. The sloped portion 208 terminates in a distal peripheral edge 212, the peripheral edge 212 being positioned more proximate the base portion 128 than the rest of the shield structure 184. The peripheral edge 212 defines the boundary where the shield structure 184 meets or overhangs other components of the device, and at least partially defines the open space 144. In the example shown, a groove 216 separates the central panel 188 and the sloped portion 208. In other examples, the central panel 188 is continuous with the sloped portion 208. In some embodiments, the shield structure 184 is designed with varying degrees of transparency or translucency in different regions, which affects how light is emitted from the device 100. In some embodiments, the peripheral edge 212 and/or sloped portion 208 of the shield structure 184 is translucent (e.g., have a frosted texture), and light from the light bar 140 in the base portion 128 transmits through portions of the shield structure 184 to provide a visual effect.

In addition to shielding the planar substrate 112 from direct view by a user, in some embodiments, the shield structure 184 performs one or more functional roles related to insect attraction and device performance. In some embodiments, the shield structure 184 defines a physical boundary that limits direct frontal visibility of the adhesive substrate 112 while permitting peripheral access to the open space 144 by insects approaching from lateral (along axis B), vertical (along axis C), or oblique directions. This configuration encourages insects to enter the open space 144 through perimeter openings rather than approaching the device directly from the front. In certain embodiments, the geometry of the shield structure 184 is configured to influence airflow, light distribution, or insect approach behavior. For example, in some embodiments, the domed and sloped portion 208 of the shield structure 184 create shaded regions, visual contrast zones, or light gradients that insects are biologically predisposed to investigate. In some embodiments, the shield structure 184 further serves as an optical reflector, redirecting light emitted from within the base portion 128 back into the open space 144 or outward toward a surrounding surface (not shown) to create a secondary visual cue. In some embodiments, portions of the shield structure 184 are at least partially translucent or semi-transparent, such that light emitted by the insect trap device 100 is visible through the shield structure 184 itself. In some embodiments, this creates a glowing or halo effect that increases the effective attraction radius of the insect trap device 100 while still preventing direct line-of-sight visibility of captured insects on the substrate 112. The insect trap 100 is configured to improve user acceptance by minimizing or eliminating direct visibility of captured insects during normal use. In some embodiments, obscuring the adhesive substrate 112 from frontal view reduces user discomfort, embarrassment, or aversion commonly associated with pest control products. This design consideration is particularly beneficial in residential, hospitality, and office environments where users prefer unobtrusive, aesthetically neutral devices. By presenting an appearance more closely resembling ambient lighting, decorative objects, or home accessories rather than traditional pest control equipment, the insect trap 100 may be placed in visible, high-traffic locations where insect activity is more frequent. Increased willingness by users to position the insect trap in optimal locations results in improved overall insect capture performance without requiring any increase in device size, power consumption, or operating complexity.

In the illustrated example, the dimming button 192, power button 196, and light sensor 200 are circular elements and are linearly arranged along a lateral axis (i.e., an axis parallel with axis B) that intercepts the center of each of the dimming button 192, the power button 196, and the light sensor 200. In some embodiments, these elements allow users to control device functions and receive visual feedback on device status. In some embodiments, the power button 196 turns the device 100 on and off. In some embodiments, the dimming button 192 (e.g., mode button) controls different modes of operation for the insect trap device 100. For example, in some aspects, the insect trap device 100 defaults to a high intensity mode where the visible and UV LEDs shining through the light bar 140 operates at maximum intensity. In some embodiments, pressing the dimming button 192 switches the operation of the LEDs to a dimming mode. In some embodiments in the dimming mode, the visible LEDs are dimmed in response to sensed ambient light dimming, which reduces power consumption in some embodiments. In some implementations, pressing and holding the dimming button 192 allows a user to manually set a desired intensity level for the visible lights. This functionality provides users with additional control over the device's operation to suit their preferences or specific environmental conditions. In other examples, buttons of an insect trap device are arranged in other patterns on a front panel of the device (e.g., in an array, aligned along a vertical axis, etc.).

In some embodiments, the insect trap device 100 includes other control elements engageable by a user to control operation of the insect trap device. For example, in some embodiments, the insect trap device 100 includes a three-position slider switch (not shown) at the central panel 188 (e.g., instead of buttons 192, 196), and the three position slider switch is moved between an “off” position, an “on” position, and an “auto” position. When the three-position switch (not shown) is in the “off” position, insect attractant LEDs (e.g., LEDs housed within the base portion 128) are powered off. When the three-position switch (not shown) is in the “on” position, the insect attractant LEDs operate at a preset intensity (e.g., UV LEDs and visible light LEDs operate at maximum intensity). When the three-position switch (not shown) is in the “auto” position, an intensity of insect attractant LEDs is varied according to preset algorithms. In other examples, the dimming button 192 is a slider switch, a knob, or other multi-position control element. In some embodiments, the central panel 188 of the insect trap device 100 includes a touch screen control, allowing a user to power the device on and off and control a mode (e.g., a mode determining an intensity of LED lights of the insect trap device) via controls displayed on the touch screen control. In some embodiments, the insect trap device 100 incorporates a small digital display that shows current settings, battery life, or other relevant information. In some embodiments, this display is accompanied by small tactile buttons for navigating through menu options or adjusting specific parameters.

In some embodiments, operation of the insect trap device 100 is adjusted based on environmental conditions (e.g., ambient light levels). It is beneficial to conserve power in operation, and an intensity of a visible light of an insect trap device 100 is adjusted to achieve power savings, which increases a battery life of the insect trap device 100. In some embodiments, when an ambient light is dim or darkens, it is unnecessary to operate visible light attractants (e.g., blue LEDs) of an insect trap at a maximum intensity, as a contrast between the light emitted and the ambient light is sufficient to draw insects to the trap. In some embodiments, an insect trap device (e.g., insect trap device 100) includes the light sensor 200 positioned within the central panel 188 of the shield structure 184. In some embodiments, the light sensor 200 comprises a photovoltaic cell that is configured to measure incremental changes of light level in an environment. In some examples, the light sensor 200 comprises one of a photodiode, phototransistor, photoresistor, a charge-coupled device, a complementary metal-oxide semiconductor, etc. Unlike conventional light-based insect traps that rely primarily on darkness to enhance a point-source light contrast, the present insect trap 100 leverages a combination of visible light, ultraviolet light, internal reflection, and volumetric light distribution to create a visually complex attraction region within the open space 144 of the device 100. This illumination configuration stimulates insect approach behavior even when ambient light levels are relatively high.

Referring to FIG. 2, an insect trap device, according to the present disclosure, includes features for allowing the insect trap device to operate in a wall-mount configuration or a free-standing (e.g., portable) configuration. As illustrated in FIG. 2, in some embodiments, the insect trap device 100 include electrical prongs 220. In some embodiments, the electrical prongs 220 are rotatable about a rotation axis parallel to axis B between an extended position (e.g., as shown in FIG. 12 showing electrical prongs 220 in an extended position) and a retracted position. In FIG. 2, the prongs 220 are shown in the retracted position, and are received within a storage cavity 224 of the base portion 128. When the prongs 220 are in an extended position, the prongs 220 are received within an electrical outlet of a wall (not shown), and the insect trap device 100 will thereby be mounted to the wall (not shown). When the insect trap device 100 is mounted to a wall, the rear surface 132 of the base portion 128 (e.g., a distal surface along an axis parallel to axis A) faces the wall (not shown), and the insertion direction of the refill 112 is parallel with respect to the direction of gravity (e.g., the vertical axis C is parallel to a direction in which the force of gravity operates), although it will be appreciated that the orientation of the insect trap device 100 and the refill 112 varies depending on the orientation of the wall outlet. As further shown in FIG. 2, the insect trap device 100 includes a plurality of base pads 228. The plurality of base pads 228 protrude outwardly from the rear surface 132 of the base portion 128, and provide a surface for engaging a support surface (e.g., a table top, a counter top, a shelf, etc.) when the insect trap device 100 is in a free-standing configuration. In some embodiments, the plurality of base pads 228 are formed of a different material than the base portion 128. For example, in some embodiments, the plurality of base pads 228 are rubber, as it advantageously increases a friction (e.g., to reduce slipping or displacement) between the insect trap device 100 and a support surface (not shown) when the insect trap device 100 is operated in the free-standing configuration. In other examples, the plurality of base pads 228 are formed from any material that is configured to provide resistance to displacement of the insect trap device 100 relative to a support surface. In the illustrated example, the plurality of base pads 228 are circular. In other examples, the plurality of base pads 228 comprise any shape. The insect trap device 100 includes three base pads 228, though it can have at least one pad, at least two pads, at least three pads, or more than three pads. Further, in some embodiments, the rear surface 132 of the base portion 128 includes a recessed surface 232. The recessed surface 232 includes text or iconography therein. In some embodiments, the recessed surface 232 is replaced with a removable panel that provides a user access to a battery 236 (see FIG. 11) to allow the user to change the battery 236 (see FIG. 11). As such, the insect trap device 100 maintains a clean, minimalist aesthetic with smooth transitions between surfaces, presenting an unobtrusive profile suitable for residential use. The design integrates functional aspects of an insect trap with simplified external aesthetics, featuring gentle curves and minimal visible mechanical elements.

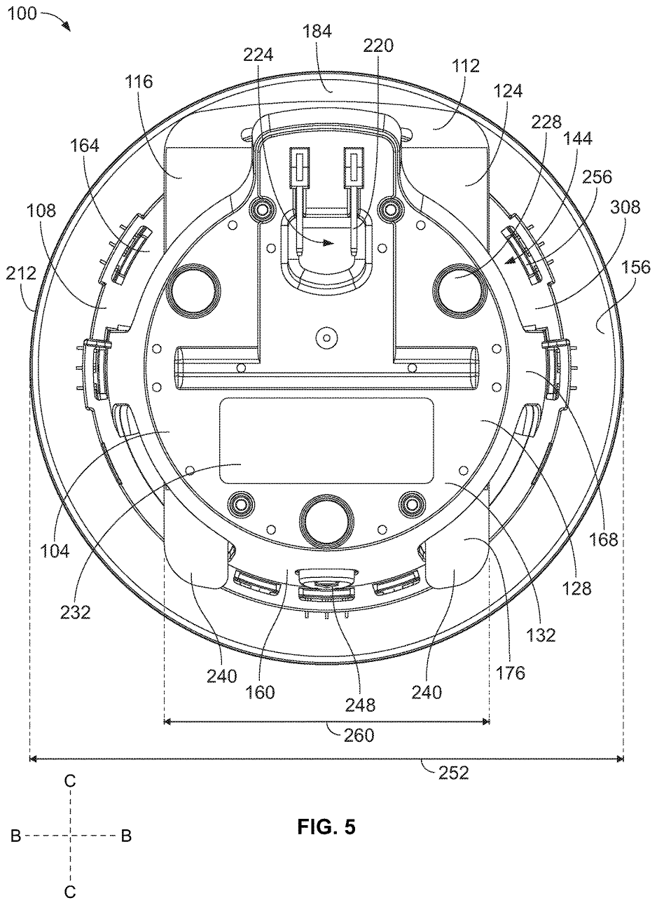

As discussed above, in some embodiments, the insect trap device 100 includes guide features to assist a user in positioning, inserting, and installing a refill substrate 112 on the insect trap device 100. As further illustrated in FIG. 2, the substrate 112 and the bottom pillar 160 are sized and configured to retain the substrate 112 relative to the rear and front housings 104, 108, and to provide tactile guidance to a user in installing and correctly positioning the substrate 112. As shown, the substrate 112 includes lateral legs 240 that extend downwardly from the substrate 112 (e.g., in the insertion direction parallel to axis C). As shown, the lateral legs 240 at least partially overhang the bottom pillar 160 when the substrate 112 is installed within the open space 144. As shown in FIGS. 11 and 12, in some embodiments the substrate 112 includes opposing lateral legs 240 on opposite lateral sides of the substrate 112, and the legs 240 define a gap 244 (see FIG. 11). Returning to FIG. 2, when the substrate 112 is installed, in some embodiments, the bottom pillar 160 is received into the gap 244 of the substrate 112 between opposing lateral legs 240, and both of the lateral legs 240 overhang the bottom pillar 160 on opposite lateral sides of the bottom pillar 160, such that the substrate 112 surrounds the bottom pillar 160 on three sides (as further shown in FIG. 5). The engagement of the lateral legs 240 and the bottom pillar 160 limit lateral displacement of the substrate 112 relative to the bottom pillar 160, and provide an indication to a user that the refill 112 is correctly installed.

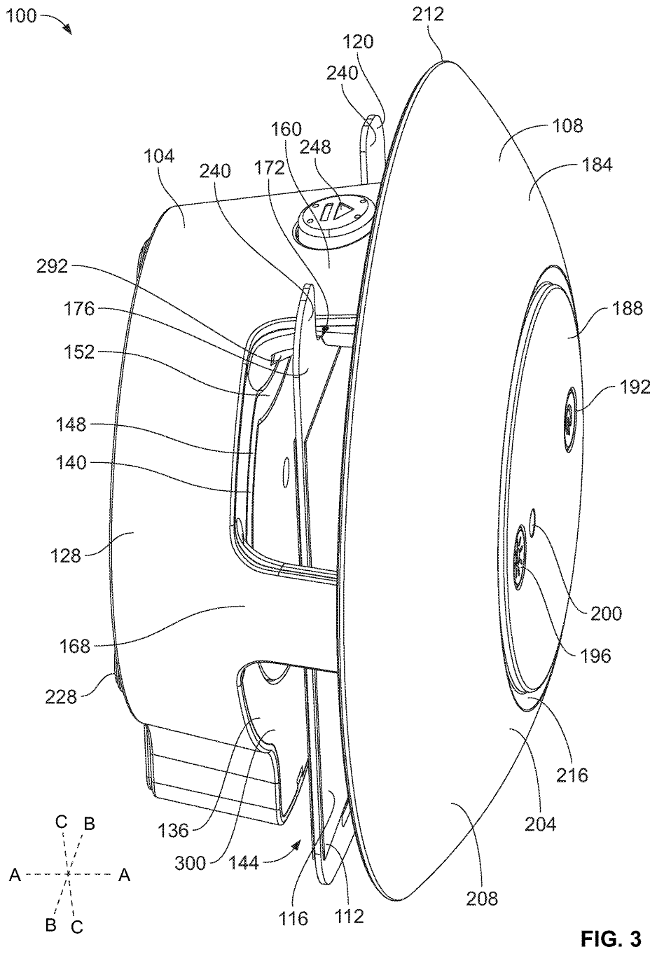

Now referring to FIG. 3, in some embodiments, the refill substrate 112 is releasably retained within the insect trap 100, and a user engages a feature of the insect trap device 100 to release the substrate 112 from the insect trap device 100. For example, in some embodiments, a desires to avoid physical contact with a used refill, and instead engages a feature of the insect trap device 100 to release the refill substrate 112 from the insect trap device 100 for disposal (e.g., to allow the substrate 112 to drop into a garbage receptacle). As shown in FIG. 3, in some embodiments, the insect trap device 100 includes an eject button 248. In some embodiments, the eject button 248 is positioned on the bottom pillar 160. In the illustrated example, the eject button 248 is circular, and includes an “eject” symbol to communicate the function of the button to a user. In some embodiments, the eject button 248 is mechanically linked to the retention mechanism 180 (see FIG. 8) that retains the substrate 112 relative to the bottom pillar 160. Engaging the eject button 248 (e.g., pushing or depressing the eject button 248) will disengage the retention mechanism 180 (see FIG. 8), and allows removal of the substrate 112 without opposition. In some embodiments, a user removes the substrate 112 without engaging the eject button 248 of the insect trap device 100. In some embodiments, a user removes the substrate 112 by pulling the refill 112 in a direction opposite the insertion direction, and when a removal force exerted by the user overcomes a retention force provided by the retention mechanism (see FIG. 8), the substrate 112 will be removed. In some embodiments, engaging the eject button 248 will remove any retention force, and thus provide relatively easy or contactless removal of the substrate 112 for disposal.

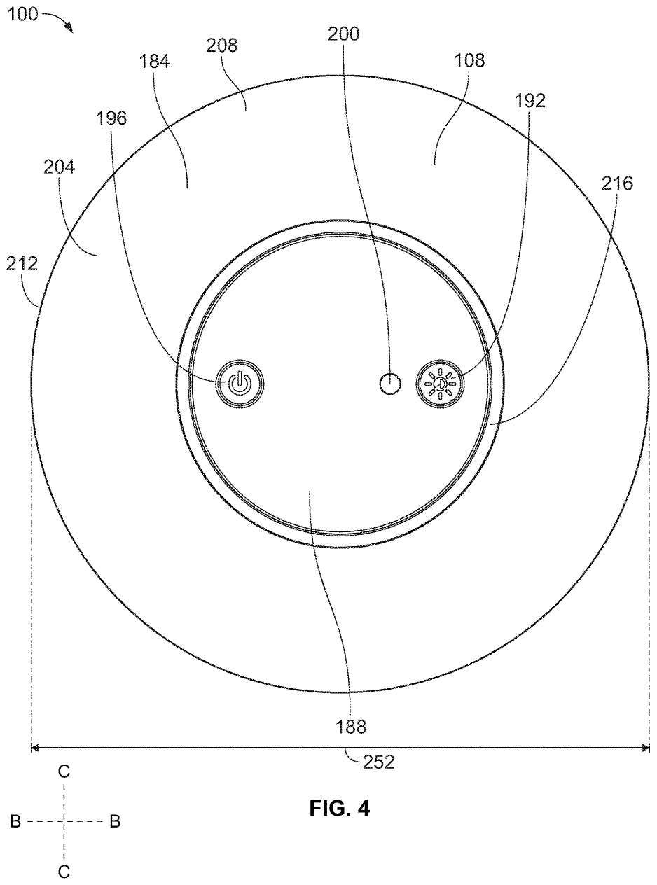

Now referring to FIG. 4, in some examples of the present disclosure, the shield structure of the insect trapping device 100 is configured (e.g., sized and positioned) to obstruct visibility of a refill substrate from one or more perspectives or views. As illustrated in FIG. 4, the shield structure 184 is sized to completely obstruct a view of the substrate 112 (see FIG. 3) from the perspective of a user viewing the insect trap device 100 from a front perspective (e.g., a user positioned on a side of the shield structure 184 opposite the base portion 128 (see FIG. 3) along an axis parallel to the axis A shown in FIG. 1). A diameter 252 of the shield structure 184 exceeds the maximum distance between any two points along the substrate 112 (see FIG. 3) (e.g., a distance between opposing corners of the substrate 112), and from this front plan view of the insect trap device 100, only the shield structure 184 is visible. As shown in FIG. 5, a total area defined by either side 120, 124 (see FIG. 3) of the substrate 112 (see FIG. 3) is less than a cross-sectional area of the shield structure 184 along a plane that is perpendicular to the axis A. Further, as shown in FIG. 5, when the substrate 112 (see FIG. 3) is installed, no part of the substrate 112 (see FIG. 3) extends beyond the peripheral edge 212 of the shield structure 184 in either of a vertical direction (e.g., a direction along an axis parallel to axis C) or a lateral direction (e.g., a direction along an axis parallel to axis B).

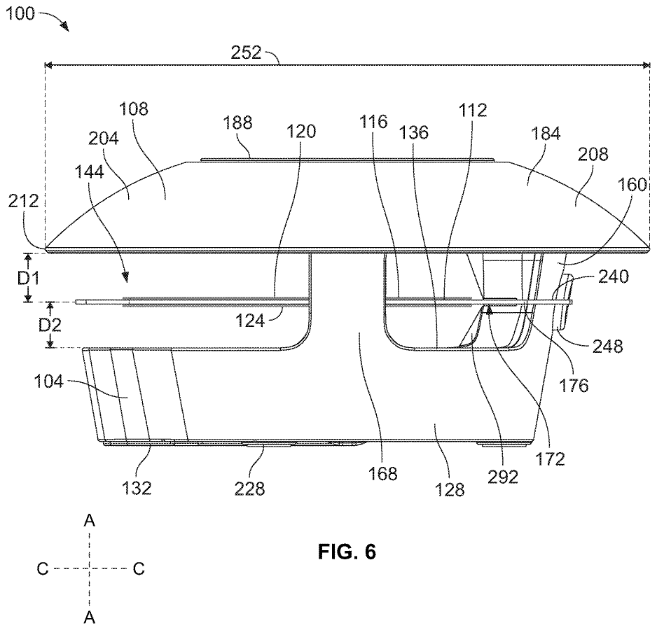

Referring now to FIG. 6, in some examples, the open space 144 is configured to maximize available openings for entry of insects, and for access of insects to the adhesive surfaces 116 of the substrate 112. As shown, the open space 144 is defined by the front housing 108 and the base portion 128, with a distance between the front housing 108 and the base portion 128 being determinative of both a volume of the space, and an area into which insects enter into the open space 144). As shown, an opening into the open space 144 (e.g., an area free from obstructions to entry by an insect) is defined by the peripheral edge 212 and the front surface 136 of the base portion 128. In some embodiments, the insect trap device 100 is symmetrical about an axis positioned laterally central to the device 100 and parallel with axis C, such that the features and dimensions shown in FIG. 6 are a mirror image of the view from the opposite lateral side of the insect trap device 100. As illustrated, the open space 144 is unobstructed except at the space where the pillars 160, 168 extend between the base portion 128 and the front housing 108. As shown, open space 144 is uninterrupted except at the pillars 160, 168. In the example shown, a total area of the open space 144 obstructed by the pillars 160, 168 is less than about 30% of a total area of the open space 144 along plane C-B, leaving greater than about 70% of the open space 144 open for entry of insects into the open space. Additionally, as best shown in FIG. 5, the disc structure 164 also includes tabs 256 that connect with the shield structure 184, helping to secure the internal components, as shown in FIG. 11. In some embodiments, the tabs 256 engage with the shield structure 184 through a snap engagement.

Referring again to FIG. 6, in some embodiments, it is advantageous to position the substrate 112 centrally along the heights of the pillars 160, 168 within the open space 144, as it provides insects equal access to the front side 120 and the rear side 124 of the substrate 112 coated with adhesive. As shown, in some embodiments, when the substrate 112 is installed within the open space 144 (e.g., when the substrate 112 is received into the slot 172 defined in the bottom pillar 160 shown in FIG. 8), the center of the refill 112 is spaced apart from the peripheral edge 212 by a distance D1 (e.g., as measured along an axis parallel to axis A), and is spaced apart from the front surface 136 of the base portion 128 by a distance D2. In the example shown, a ratio between the distance D1 and the distance D2 is about 1.0. In some examples, D1 and D2 are equal (e.g., the substrate 112 is positioned substantially centrally between a plane defined by the peripheral edge 212 and a plane defined by the front surface 136 of the base portion 128). In other examples, the substrate 112 is positioned proximate to the front surface 136 of the base portion 128, or to the rear surface 156 (see FIG. 5) of the front housing 108. In some examples, the insect trap device 100 includes multiple slots as it allows the insect trap device to simultaneously support multiple substrate refills. In some examples, a substrate includes an adhesive on only one side of the substrate.

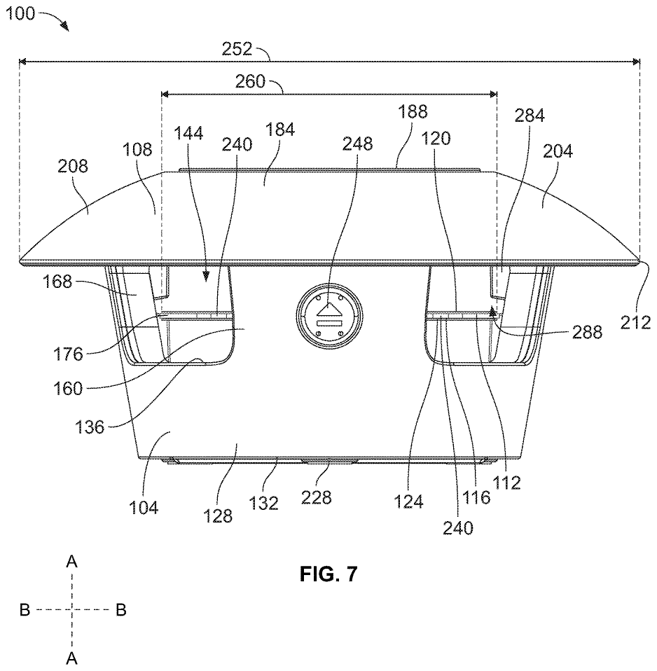

As shown in FIG. 7, when the substrate 112 is received into the open space 144 between the base portion 128 and the front housing 108, the substrate 112 is centrally positioned between the opposing lateral pillars 168. In some embodiments, the lateral pillars 168 constrain lateral displacement of the substrate 112 and partially function as guide features to aid a user in installing the substrate within the open space 144. In some embodiments, lateral pillars are positioned to be in contact with opposing lateral edges of a substrate when the substrate is installed in an insect trap device. In some embodiments, lateral pillars include guide features or retention features for a substrate (e.g., instead of or in addition to a slot of a bottom pillar). For example, in some embodiments, lateral pillars have slots including latches to engage corresponding features (e.g., apertures, detents, indentations, etc.) of a substrate and hold the substrate in place. In some embodiments, an insect trap does not include a bottom pillar, but rather includes guide features (e.g., slots) in lateral pillars to support a substrate within an insect trap device.

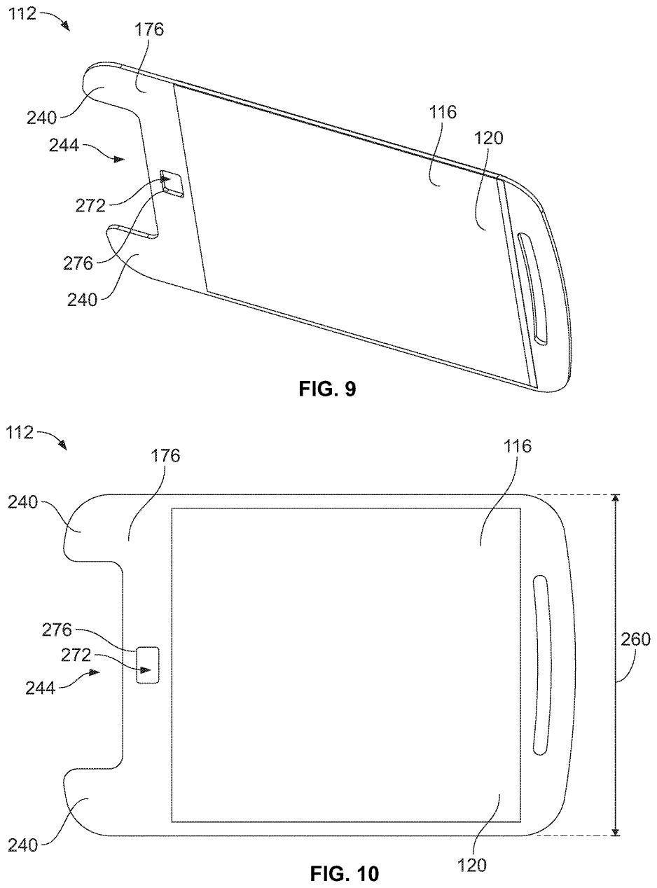

Referring now to FIG. 8, the insect trap device 100 is shown with the refill 112 removed for clarity. As noted above, the insect trap device 100 includes the slot 172. In some embodiments, the slot 172 is defined in the bottom pillar 160, and has a width that is greater than a width 260 (see FIG. 10) of the substrate 112 (see FIG. 7). In some embodiments, an opening 264 of the slot 172 faces in a direction opposite the insertion direction as it allows the slot 172 to receive the substrate 112 (see FIG. 7) when the substrate 112 (see FIG. 7) is inserted downward in the insertion direction. As shown, in some embodiments, a latch 268 extends into the slot 172 (e.g., the latch 268 extends to a position between opposing sidewalls of the slot 172). In some embodiments, the latch 268 is laterally centrally positioned within the slot 172, and aligns with a retention feature 272 (e.g., a retention aperture) (see FIG. 10) of the substrate 112 (see FIG. 10). For example, in some embodiments, as shown in FIGS. 9 and 10, the substrate 112 defines a retention aperture 272 in the bottom portion 176 of the substrate 112, and the retention aperture 272 is substantially centered in a lateral direction (e.g., in the lateral center of the gap 244) of the substrate 112. It is contemplated that the substrate 112 is similar to those disclosed in U.S. Pat. Nos. 11,484,022, and 12,290,060, which are all commonly assigned to S. C. Johnson & Son, Inc. and incorporated by reference in their entirety herein.

Referring to FIGS. 9 and 10, in some embodiments, the planar substrate 112 are configured with one or more adhesive regions having differing adhesive properties across the front side 120 and/or the rear side 124 of the substrate 112. In some embodiments, the substrate 112 has non-adhesive regions that reduce inadvertent contact during handling and installation. In some embodiments, the adhesive surface 116 is applied in patterns, gradients, or discrete regions to optimize capture efficiency for different insect species. In some embodiments, the adhesive surface 116 is covered with a peel-off film (not shown). In certain embodiments, the substrate 112 includes visual features that enhance insect attraction when illuminated. Such features includes printed patterns, contrasting regions, symbols, or color variations that become more pronounced when exposed to visible or ultraviolet light. In some embodiments, the substrate material itself is transparent, translucent, or selectively opaque, such that light emitted toward one surface of the substrate passes through or around the substrate to illuminate an opposing surface. In alternative implementations, the substrate 112 is formed as a rigid, semi-rigid, or flexible structure and includes folds, bends, or curvature. In some embodiments, the substrate 112 is single-use or multiple-use, and includes non-adhesive grasping regions, pull tabs, or reinforced edges to facilitate removal without contacting adhesive surface 116.

Referring to FIGS. 8 and 9, in some embodiments, when the substrate 112 is inserted between the opposing lateral pillars 168, the retention aperture 272 is aligned with the latch 268. In some embodiments, a user exerts a force on the substrate 112 in the insertion direction, and the latch 268 is displaced in response to the force, allowing the substrate 112 to be received into the slot 172. In some embodiments, when the substrate 112 is in an installed position, the retention aperture 272 and the latch 268 align, and the latch 268 returns to its original position. The latch 268 is received through the retention aperture 272 when the substrate 112 is installed, and opposes a removal of the substrate 112 by engagement with an edge 276 of the retention aperture 272 (e.g., in the insertion direction). In some embodiments, the latch 268 is configured to deflect outwardly when a removal force is applied to the substrate 112 in a direction opposite the insertion direction, as it allows a user to manually remove the substrate 112. As noted above, in some embodiments, the insect trap device 100 includes the eject button 248. In some embodiments, the eject button 248 is mechanically linked with the latch 268, and depression of the eject button 248 will disengage the latch 268 (e.g., causes the latch 268 to release the substrate 112). In some embodiments, the eject button 248 is of unitary construction with the latch 268 (e.g., both the eject button 248 and the latch 268 are formed from the same molded plastic piece). In some embodiments, the eject button 248 is spring-biased into an “engaged” position such that the eject button 248 and the latch 268 return to an engaged position when the user is no longer pressing the eject button 248. In some embodiments, the device 100 includes a spring 280 (see FIG. 11) configured to bias the eject button 248 in the “engaged” position. This spring-loaded mechanism allows for smooth operation of the eject function and provide tactile feedback to the user. In other examples, an eject mechanism for releasing a substrate of an insect trap device includes a slider that is moved between respective positions for engagement or disengagement of a latch. In some examples, an eject button is positioned along an insect trap device at any position comfortable for a user. For example, in some embodiments an eject button is provided on a lateral pillar (e.g., either of lateral pillars 168), at a back surface of a base portion, at a front of a shield structure, etc. By enabling release of the substrate 112 through a user-engageable eject button 248, the device 100 allows used substrates to be discarded without direct contact with insects or adhesive materials. This contactless replacement capability reduces user exposure to allergens, pathogens, or contamination associated with trapped insects. In certain applications, minimizing contact during maintenance encourages timely replacement of substrates. Additionally, reducing user reluctance to replace the substrate 112 helps maintain consistent trapping performance throughout the operational life of the device 100.

Referring again to FIG. 8, the lateral pillars 168 include ribs 284 that extend therefrom. Each lateral pillar 168 includes two ribs 284 that define a passageway 288 therebetween. The ribs 284 help align the substrate 112 (see FIG. 7) with the slot 172. Therefore, when inserting the substrate 112 (see FIG. 7) into the insect trap device 100, the user will slide the substrate 112 (see FIG. 7) through the passageway 288 formed between the ribs 284. In some embodiments, the passageway 288 comprise a smallest width, i.e., smallest distance between the two respective ribs 284 on one of the lateral pillars 168, of between about 110% and 500%, or between about 120% and 400%, or between about 130% and about 350%, or between about 150% and about 300%, or between about 160% and about 250% of a maximum width 260 of the substrate 112 (see FIG. 7), i.e., measured into the page of FIG. 5. As further shown in FIG. 8, the insect trap device 100 includes ramps 292 positioned adjacent to the slot 172. The ramps 292 are positioned on the bottom pillar 160 and assist in guiding the substrate 112 (see FIG. 7) into the slot 172. The insect trap device 100 includes four ramps 292, however, it is contemplated that the insect trap device 100 includes any number of ramps 292.

FIGS. 11 and 12 illustrate exploded views of the insect trap device 100. In these views, the rotatable electrical prongs 220 are in the extended position. As shown in FIG. 11, the insect trap device 100 includes the battery 236. In the illustrated example, the battery 236 is rechargeable. For example, in some embodiments, when the insect trap device 100 is plugged into a wall (not shown) in a wall-mount configuration, with electrical prongs 220 received into a corresponding outlet (not shown), a power from the outlet (e.g., 120 V AC power) is provided to the battery 236 to charge the battery 236. In some embodiments, a power converter is provided within the insect trap device 100 to convert the AC power from a wall outlet into a DC voltage and current for charging the battery 236 and operating the electronics of the device 100. In the example shown, the battery 236 is a lithium-ion battery. In other examples, a battery of an insect trap is any other known battery type, including, for example, nickel-cadmium batteries, alkaline rechargeable batteries, sodium-ion batteries, etc. In some embodiments, an insect trap device includes multiple batteries. In testing, a lithium-ion battery (e.g., the lithium ion battery 236) was found to be capable of operating an insect trap device for about 80-100 hours on a single charge. In some examples, batteries of an insect trap device are replaceable (e.g., replaceable rechargeable batteries or non-rechargeable batteries). For example, in some embodiments, an insect trap device includes a battery compartment that is accessible to a user upon removal of a battery cover, and removal of the battery cover provides the user access to replace batteries of the device.

As further shown in FIGS. 11 and 12, in some embodiments, the rear housing 104 includes a bottom PCB 296 positioned within the base portion 128 of the insect trap device 100 and is configured to manage electrical power delivery to one or more electrical loads of the insect trap device 100. In some embodiments, the bottom PCB 296 serves as a primary power distribution platform, receiving electrical power from one or more power sources and selectively supplying such power to lighting elements, user interface components, sensors, and other electronic components of the device. In some embodiments, the bottom PCB 296 is electrically coupled to an external power source via the electrically conductive prongs 220 configured for engagement with an electrical outlet (not shown), and is additionally electrically coupled to the battery 236 housed within the base portion 128. In this manner, the bottom PCB 296 is configured to receive power from either the external power source (not shown), the battery 236, or both, depending on operating conditions and configuration of the device. In certain embodiments, the bottom PCB 296 includes power conditioning circuitry configured to prepare received electrical power for use by downstream components. Such circuitry includes, for example, one or more rectifiers, voltage regulators, current limiting elements, power converters, protection elements, or combinations thereof. In some embodiments, when the insect trap 100 is connected to an external AC power source, the bottom PCB 296 converts the received AC power into a suitable DC voltage for powering electronic components and for charging the battery 236. In some embodiments, when operating from the battery 236, the bottom PCB 296 regulates battery output to maintains stable operation of the device 100. In some embodiments, the bottom PCB 296 further includes conductive traces, connectors, or contact pads configured to route conditioned electrical power to the plurality of lighting elements, including visible light LEDs and ultraviolet LEDs, as well as to one or more control components such as buttons, sensors, indicator lights, or additional printed circuit boards positioned elsewhere within the insect trap 100. In some embodiments, the bottom PCB 296 functions as a centralized electrical hub through which substantially all operating power for the insect trap device 100 flows.

Still referring to FIGS. 11 and 12, in embodiments including the rechargeable battery 236, the bottom PCB 296 incorporates battery management circuitry configured to control charging, discharging, and protection of the battery 236. Such battery management circuitry includes charge controllers, over-voltage protection, over-current protection, thermal protection, and charge state monitoring components. In some embodiments, the bottom PCB 296 thus enables safe charging of the battery 236 when the insect trap device 100 is connected to an external power source (not shown) and safe operation of the insect trap device 100 when powered by the battery 236. In some embodiments, the bottom PCB 296 is configured to automatically transition between external power operation and battery-powered operation without interrupting illumination of the lighting elements. This seamless power transition improves usability and ensures continuous insect trapping during removal from an outlet or during temporary power interruptions. This dual-power capability, through either the battery 236 or the wall outlet (not shown), provides increased flexibility in placement and use, allowing the insect trap device 100 to be positioned in locations where insect activity is greatest rather than being constrained solely by outlet availability. In some embodiments, the ability to operate independently of continuous outlet power enables temporary or portable use of the insect trap device 100, including placement on shelves, countertops, or other free-standing surfaces. In some embodiments, such flexibility improves trapping effectiveness by permitting relocation of the device based on seasonal changes or user preferences, all while maintaining consistent operating behavior.

Referring to FIG. 11, a rear housing insert 300 is provided, and collectively, the rear housing insert 300 and the rear housing 104 enclose the electrical components of the base portion 128 (e.g., the battery 236 and the bottom PCB 296). The front surface 136 of the base portion 128 is defined on the rear housing insert 300, and the rear housing insert 300 further defines a groove 304 for receiving the light bar 140. The eject button 248 is provided with the latch 268, and the eject button 248 and latch 268 are received into the rear housing 104. When so received, the latch 268 extends into the slot 172 (see FIG. 8) to selectively engage or disengage a corresponding retention aperture (e.g., retention aperture 272 shown in FIGS. 9 and 10) of the substrate 112.

Referring still to FIGS. 11 and 12, the front housing 108 includes the shield structure 184 and the disc structure 164. An interior surface 308 of the disc structure 164 is shown in FIG. 12. Collectively, in some embodiments, the shield structure 184 and the disc structure 164 define an enclosure for electronics in the front housing 108. For example, in some embodiments, a control PCB 312 is provided within the front housing 108 between the disc structure 164 and the shield structure 184. In some embodiments, the control PCB 312 has mounted thereon button elements corresponding to the power button 196 and the dimming button 192, the button elements being configured to produce a signal or route a current in response to a depression of the corresponding button 192, 196. Further, in some embodiments, indicator lights 316 and the light sensor 200 are mounted on the control PCB 312. In some embodiments, the control PCB 312 further includes logic components (e.g., a processor, controller, memory element, etc.) to implement a control in response to depression of one or more buttons 192, 196 by a user. For example, in some embodiments, the control PCB 312 is in electrical communication with the bottom PCB 296 (e.g., via a wired connection, with the wire extending through one or multiple of the pillars 168, 160). In response to the power button 196 being pressed, a circuit is interrupted, or a signal is provided to either stop a flow of power to the LEDs of the light bar 140 (e.g., turn off the LEDs), or start a flow of power to the LEDs (e.g., turn on the LEDs).

In some implementations, the bottom PCB 296 is electrically coupled to the control PCB 312 that is positioned within the front housing 108 of the insect trap 100. In some embodiments, electrical communication between the bottom PCB 296 and the control PCB 312 is established via one or more conductive wires, flexible circuits, connectors, or conductive paths extending through one or more structural members of the device 100. An electrical communication medium 320 shown in more detail in FIG. 12. Through this communication pathway of the electrical communication medium 320, referring back to FIG. 11, control signals generated by the control PCB 312 direct operation of lighting elements powered by the bottom PCB 296. In such embodiments, the bottom PCB 296 includes driver circuitry configured to selectively energize individual lighting elements or groups of lighting elements in response to control signals. For example, in some embodiments, the bottom PCB 296 independently controls visible light LEDs and ultraviolet LEDs, permitting different operating modes, illumination intensities, or duty cycles without requiring separate power boards for each lighting type.

In some embodiments, the control PCB 312 implements control of the light bar 140 in response to a user engaging the dimming button 192. The dimming button 192 also function as a mode button in this scenario. For example, in some embodiments, the control PCB 312 is configured (e.g., wired and programmed) to cycle between one of an “on” mode, a “dimming” operation, and an “auto” mode in response to respective engagements of the dimming button 192 by a user. In the “on” mode, the UV and visible light LEDs (e.g., blue light LEDs) remain activated at all times. In the “Auto” mode, the UV and visible LEDs of the light bar 140 are activated until the light sensor 200 detects ambient light has crossed above a threshold value. In some embodiments, the light bar 140 will reactivate once the ambient light source drops below a second threshold value, which is less than the original threshold value. By automatically adjusting illumination intensity or operating state based on ambient light conditions, user preferences, or elapsed operating time, the device 100 reduces energy consumption while maintaining effective insect capture. Such adaptive behavior extends battery life during portable operation and reduce overall power usage during continuous operation. In some embodiments, a hysteresis-style control algorithm is used to ensure that the light bar 140 is not repeatedly turning on and off in response to a measured value of ambient light from the light sensor 200. In some embodiments, switching between the “on” and “auto” modes requires pressing the dimming button 192 when the insect trap device 100 is operating in one mode to cycle it to operation in the other mode.

In some embodiments, pressing and holding one or both of the buttons 192, 196 sets a static intensity of the light bar 140. In some examples, a static intensity (e.g., a level of dimness) of the light bar 140 is adjusted by pressing and holding the dimming button 192. In response to the dimming button 192 being held, the light bar 140 slowly dims until the user reaches a preferred light level, at which point the user will release the dimming button 192. In some examples, the device 100 has a memory (e.g., at the control PCB 312) to store this selected light-level value such that if the device 100 is deactivated in auto mode (e.g., because a high ambient light was detected), the light bar 140 will return to the selected dimming value upon reactivating. In some embodiments the light bar 140 will reactivate at 100%. In some embodiments, only visible LEDs of the light bar 140 are dimmed in response to a dimming operation, and UV LEDs will remain at 100% intensity regardless of the dimming level of the visible LEDs.

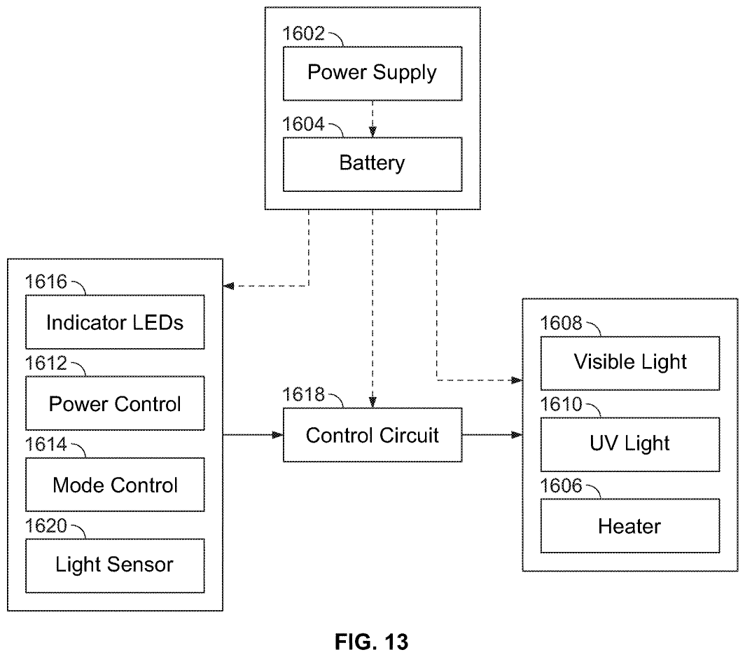

In some embodiments, a front housing of an insect trap device further includes one or more PCBs having an electrical load that is controllable by operation of buttons (e.g., buttons 192, 196) or other controls of the insect trap device. For example, in some embodiments, a PCB including LEDs is housed within a front housing, and light from the LEDs is directed backwards into an open space of the insect trap device. In some embodiments, an insect trap device includes a heater (e.g., a heating resistor) that uses heat to attract insects to the insect trap device. In some embodiments, a heater (not shown) is housed within either or both of the front housing 108 and the rear housing 104 and is configured to provide heat to a substrate. In some embodiments, a heater is housed in a pillar of an insect trap device (e.g., the bottom pillar 160). In some embodiments, a heater operates at a preset setting when the insect trap device is in use. In some embodiments, a heat level of the heater is adjusted in response to a user engagement of a control of the insect trap (e.g., similar to the dimming operation described above). FIG. 13 illustrates an example circuit diagram for electronic implementation of the control procedures outlined herein and will be described in more detail.

FIG. 13 illustrates a block diagram of an insect trap system (e.g., a system implementable in the insect trap device 100 shown in FIGS. 1-12). The system includes a control circuit 1618 that interfaces with multiple components to manage the operation of the insect trap device 100. One or both of a power supply 1602 and battery 1604 provide power to the system, enabling both plug-in and portable operation (e.g., wall-mounted and free-standing operation). In some embodiments, the power supply 1602 corresponds to the AC power received through the electrical prongs 220, while the battery 1604 represents the rechargeable battery 236 described earlier. These power components connect to the control circuit 1618 for power distribution throughout the system. The control circuit 1618 connects to several input and output components. For the user interface, the system includes a mode control 1614 and power control 1612 (e.g., dimming and power control buttons 192, 196 described above, control knobs, sliders, switches, touchscreen elements, etc.) that provide input signals to the control circuit 1618. In some embodiments, the power control 1612 corresponds to the power button 196, while the mode control 1614 corresponds to the dimming button 192. An indicator light 1616 is connected to the control circuit 1618 and, in some embodiments, displays system status information (e.g., through an on/off status, blinking patterns, color, etc.).

In some embodiments, the control circuit 1618 manages output loads to control a visual appearance and insect attraction of an insect trap device. In some embodiments, outputs include visible light 1608 and UV light 1610 (e.g., visible and UV LEDs of the light bar 140) that serve to attract insects. In some examples, as shown, an insect trap system includes a heater 1606 connected to the control circuit 1618. An operation (e.g., an on/off status, a heat level, etc.) of the heater is controlled by the control circuit 1618, including in response to a user input at either or both of the power control and the mode control 1614. In some embodiments, the control circuit 1618 implements the various operational modes and control algorithms described earlier, such as the “on” mode, “dimming” operation, and “auto” mode. In some embodiments, it also manages the intensity control of the LEDs and the operation of the heater based on user inputs received through the mode control 1614 and power control 1612. The block diagram uses solid lines to show control or feedback signals between components, while dashed lines represent power connections. This arrangement allows the control circuit 1618 to regulate power delivery and coordinate the operation of the LEDs and heater based on inputs received through the mode control 1614 and power control 1612, as well as environmental factors detected by sensors such as the light sensor 1620 (e.g., the light sensor 200 shown in FIG. 11).

As noted herein, in some embodiments, the insect trap device 100 described herein includes a refill counter or timer that will be used to provide a refill replacement indication for the substrate 112. Therefore, the timer and the refill replacement indication will notify the user to replace the substrate 112 after a certain period of time has passed. In some embodiments, the timer is operationally connected to or a part of a PCB, e.g., the bottom PCB 296 or the control PCB 312. In some embodiments, the timer is a separate element within the insect trap device 100. These indicators or visual cues alert a user to substrate replacement or operating mode changes, without requiring active monitoring. This feature reduces user burden, promote proper maintenance, and enhance the long-term effectiveness of the insect trap device 100.

In one particular embodiment, the timer will notify the user of replacing the substrate 112 after 21 days have passed. In alternative embodiments different time periods are used, e.g., 1 week, 2 weeks, 4 weeks, etc. The timer resets to zero when the insect trap device 100 is plugged into an outlet for the very first time. Further, the timer resets to zero if the device is fully discharged and the battery is dead. In one particular implementation, the timer only counts when the insect trap device 100 is turned ON with all LEDs ON.

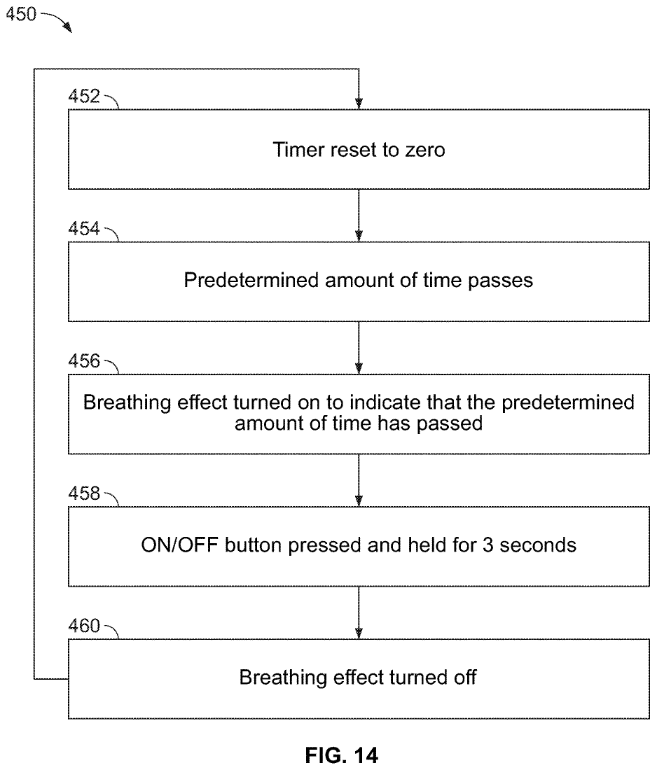

FIG. 14 illustrates a flowchart outlining a process 450 the insect trap device 100 goes through to alert the user to replace the substrate 112. While the example process is described with reference to the flowchart illustrated in FIG. 14, many other processes may alternatively be used. For example, in some embodiments, the order of execution of the blocks is rearranged, changed, eliminated, and/or combined to perform the process 450. The process includes a step 452 of resetting the timer to zero. As discussed above, in some embodiments, the timer is reset when the insect trap device 100 is plugged into an outlet for the very first time or when the insect trap device 100 is fully discharged. In some embodiments, the timer is also reset when a power button or ON/OFF button, e.g., the button 192 or the button 196, is held for at least 3 seconds.

Once the timer is reset to zero, a predetermined amount of time will pass at step 454. As discussed above, in some embodiments, the predetermined amount of time is 21 days. However, it is noted that the predetermined amount of time can be any amount or duration of time. Once the predetermined amount of time has passed, at step 456, the insect trap device 100 will initiate a breathing effect to indicate to the user that the predetermined amount of time has passed and that the substrate 112 should be replaced. The breathing effect includes one of the LEDs (e.g., a blue LED, or an amber LED) continuously dimming and brightening slowly. For example, the breathing effect includes one of the LEDs going from 10% brightness to 100% brightness in a repeated pattern to notify the user to replace the substrate 112. At this time, i.e., when the breathing effect is initiated, the button that controls different modes of operation, e.g., button 192 and/or a dimming button 192 is functionally disabled. The breathing effect will continue until the power button or ON/OFF button, e.g., the button 196 or the button 192, is pressed and held for at least 3 seconds at step 458. Then, at step 460, the breathing effect will be turned off and the timer will be reset back to step 452. When the breathing effect stops, one or more of the LEDs will remain continuously on. In some embodiments, the blue or amber LED intensity is set to the original state before the breathing effect started.

The performance of insect traps incorporating the structures and operating principles described herein has been evaluated through controlled chamber testing. In representative tests, a fixed number of flying insects were released into enclosed chambers of varying volumes, and the number of insects captured by different devices over a fixed test duration was recorded. Separate trials were conducted for different insect types, including flies and mosquitoes. In these evaluations, insect traps according to the present disclosure demonstrated higher insect capture rates when operated in a wall-mounted configuration relative to multiple comparative light-based insect trapping devices configured for wall outlet use under the same conditions. The observed performance trend was consistent across multiple chamber sizes and insect types.

The testing further indicated that device orientation and mounting configuration influences relative capture performance. In particular, the wall-mounted configuration of the disclosed insect trap exhibited improved relative performance compared to free-standing operation, consistent with embodiments in which illumination patterns, insect approach pathways, and spatial placement are optimized for vertical orientation. The described test results are provided for illustrative purposes only and represent examples of performance that are achieved by devices constructed in accordance with the present disclosure. Actual performance varies depending on environmental conditions, operating parameters, test duration, and insect species.

In order to further illustrate the comparative performance characteristics described above, results from representative testing are summarized in Table 1 below. The summarized data includes average insect capture rates observed for different device types operated in a wall-mounted configuration across multiple chamber sizes and insect types. The values presented are representative of observed trends and are provided to facilitate comparison of relative performance under controlled conditions.

TABLE 1
Representative Insect Capture
Performance in Wall-Mounted Configuration

| | Chamber | Mosquito | Fly |
|---|---|---|---|
| | Size | Capture | Capture |
| Device Type | (m\hat{ }3) | (%) | (%) |
| Present Insect Trap | 20 | 25 | 23 |
| Comparative Trap A | 20 | 25 | 15 |
| Comparative Trap B | 20 | 11 | 11 |
| Present Insect Trap | 30 | 16 | 43 |
| Comparative Trap A | 30 | 21 | 29 |
| Comparative Trap B | 30 | 3 | 21 |
| Present Insect Trap | 70 | 21 | 19 |
| Comparative Trap A | 70 | 11 | 10 |
| Comparative Trap B | 70 | 3 | 15 |

As reflected in Table 1, insect traps according to the present disclosure generally exhibit improved or comparable insect capture performance relative to the evaluated comparative devices when operated in a wall-mounted configuration. In particular, the present insect trap demonstrates consistently strong performance across multiple chamber sizes and insect types, including higher capture rates in certain conditions where comparative devices exhibit reduced efficacy. While performance varies depending on specific conditions, the data illustrates that the structural and operational features described herein contribute to enhanced trapping effectiveness in practical use scenarios.

The values presented in Table 1 represent average capture rates observed in controlled chamber testing over a limited test duration and are provided for illustrative comparative purposes only. The specific values vary depending on environmental conditions, insect species, chamber size, test duration, device positioning, and other factors. Accordingly, the data in Table 1 should not be interpreted as limiting the performance of the insect trap described herein.

Any of the embodiments described herein may be modified to include any of the structures or methodologies disclosed in connection with different embodiments. Further, the present disclosure is not limited to substrate and/or support component shapes/sizes of the type specifically shown. Still further, the support components of any of the embodiments disclosed herein may be modified to work with various types of substrates consistent with the disclosure herein.

### INDUSTRIAL APPLICABILITY

Numerous modifications to the present disclosure will be apparent to those skilled in the art in view of the foregoing description. Accordingly, this description is to be construed as illustrative only and is presented for the purpose of enabling those skilled in the art to make and use the device disclosed herein. The exclusive rights to all modifications which come within the scope of the appended claims are reserved.

We claim:

1. An insect trap, comprising:
a base portion defining a front surface and a rear surface opposite the front surface, the base portion including:
electrically conductive prongs,
a battery housed within the base portion between the front and rear surfaces,
a light bar mounted in the front surface;
a front housing including a shield structure having a first diameter, the shield structure including a central panel and a domed surface, wherein the central panel include at least one button and a light sensor, wherein the front housing is spaced apart from the base portion in a first direction, the base portion and the front housing defining an empty volume therebetween;
a pillar extending from the base portion to the front housing, the pillar at least partially joining the front housing and the base portion, wherein the pillar includes a slot; and
a planar substrate sized to be received in the slot of the pillar, wherein the first diameter of the shield structure is greater than a maximum distance between two points along the planar substrate.

2. The insect trap of claim 1, wherein the light bar is configured to direct light from a plurality of LEDs into the empty volume toward the planar substrate.

3. The insect trap of claim 1, wherein the planar substrate is transparent.

4. The insect trap of claim 1, further comprising:
an eject button positioned on the pillar; and
a latch mechanically coupled to the eject button,
wherein the planar substrate includes a retention aperture, and
wherein, when the planar substrate is received in the slot, the latch engages the retention aperture to secure the planar substrate in position.

5. The insect trap of claim 1, wherein the at least one button includes a mode button, and wherein the insect trap is configured to operate in at least two modes selectable by engaging the mode button.

6. The insect trap of claim 5, wherein the at least two modes include an “on” mode in which a plurality of LEDs remain activated, and an “auto” mode in which activation of the plurality of LEDs is controlled based on ambient light levels detected by the light sensor.

7. The insect trap of claim 6, wherein in the “auto” mode, the plurality of LEDs is deactivated when the light sensor detects ambient light above a first threshold value and reactivated when the light sensor detects ambient light below a second threshold value.

8. The insect trap of claim 1, wherein the at least one button includes a power button and a mode button, and wherein pressing and holding at least one of the power button or the mode button adjusts an intensity of at least one LED of a plurality of LEDs.

9. The insect trap of claim 8, wherein the insect trap includes a memory configured to store a user-selected intensity level, and wherein the at least one LED returns to the user-selected intensity level upon reactivation after deactivation in an auto mode.

10. An insect trap, comprising:
a base portion defining a front surface and a rear surface opposite the front surface, the base portion including a plurality of LEDs and a light bar in optical communication with the plurality of LEDs, wherein the light bar is mounted in the front surface;
a front housing including a shield structure having a first diameter, wherein the front housing is spaced apart from the base portion in a first direction, the base portion and the front housing defining an empty volume therebetween;
a pillar extending from the base portion to the front housing and including a slot; and
a planar substrate sized to be received in the slot of the pillar, wherein the first diameter of the shield structure is greater than a maximum distance between two points along an outer edge of the planar substrate.

11. The insect trap of claim 8 further comprising an eject button positioned on the pillar.

12. The insect trap of claim 8, wherein the light bar defines a generally circular profile with an indented arc.

13. The insect trap of claim 8 further comprising a battery.

14. The insect trap of claim 8, wherein the pillar includes a plurality of ramps, and wherein the plurality of ramps guides the planar substrate into the slot when inserting the planar substrate into the insect trap.

15. An insect trap, comprising:
a base portion defining a front surface and a rear surface opposite the front surface, the base portion including a light bar mounted in the front surface;
a front housing including a shield structure, wherein the front housing is spaced apart from the base portion in a first direction, the base portion and the front housing defining an empty volume therebetween;
a first pillar extending from the base portion to the front housing, the first pillar at least partially joining the front housing and the base portion, wherein the first pillar includes a slot; and
a substrate sized to be received in the slot of the first pillar, wherein, when the substrate is received in the slot of the first pillar, the substrate is spaced from the front housing and from the front surface of the base portion.

16. The insect trap of claim 15 further comprising a second pillar and a third pillar.

17. The insect trap of claim 16, wherein the first pillar, the second pillar, and the third pillar are spaced apart from each other.

18. The insect trap of claim 16, wherein the second pillar and the third pillar each comprises a plurality of ribs that define a passageway therebetween.

19. The insect trap of claim 18, wherein the substrate is positioned within the passageway of the first pillar and the second pillar when the substrate is received in the slot of the first pillar.

20. The insect trap of claim 15, wherein the substrate is positioned around the first pillar on three sides of the first pillar.
